(19) United States
(12) Patent Application Publication
(10) Pub. No.: US 2007/0268937 A1
(43) Pub. Date: Nov. 22, 2007

(54) System and Method for Linking at Least Two Multimedia Terminals Connected to Each Other Via a Landline or Cellular Network

(76) Inventors: Isabelle Kubica, Paris (FR); Celine Pernot, Lyon (FR); Laurent Leprince, Gif Sur Yvette (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/577,574

(22) PCT Filed: Oct. 27, 2003
(86) PCT No.: PCT/FR03/03191

§ 371 Date: Jun. 1, 2007

(51) Int. Cl. H04J 3/06

(52) U.S. Cl. 370/503

(57) ABSTRACT

The invention relates to linking Linking at least two multimedia terminals connected to each other via a landline or cellular network. Before a call from the terminal of a calling person to the terminal of a called person, the calling person chooses a multimedia content to be sent to the terminal of the called person and said multimedia content is received by the terminal of the called person synchronously with the reception of signaling of the call.

### TECHNICAL FIELD

The invention relates to a system and a method for linking at least two multimedia terminals connected to each other via a landline or cellular network.

### PRIOR ART

In the field of landline and mobile telecommunications, a number of services enable a called person, also referred to as the “called party”, to personalize the presentation of incoming calls:
thus in the case of mobile telephony the called person can request:
presentation of the incoming number: this service is offered by the telephone carrier or “operator”;
presentation of the name associated with the incoming number in the called party's directory: this service is offered by the terminal;
presentation of pictures and sounds associated with telephone numbers: this service is offered by the terminal; and
different ringtones depending on the category to which the calling party belongs (the called party can create these categories for the contacts in the directory in the terminal and can associate a specific ringtone with each category): this is service is offered by the terminal;
and in the case of landline telephony the called person can request:
presentation of the incoming number: this service is offered by the telephone carrier;
presentation of the name associated with the incoming number in the called party's directory: this service is offered by the terminal;
display of the name of the person or the organization as defined in the telephone directory (yellow pages and white pages) or in a virtual or non-virtual private network; and
different ringtones depending on categories (the called party can create these categories for the contacts in the directory of the terminal and can associate a specific ringtone with each category): this service is offered by the terminal.

However, in all the above solutions, it is the called party, the telephone carrier, or a third party service provider that personalizes the display on the called party's terminal.

The object of the invention is to enable the caller, also referred to as the “calling party”, to personalize the presentation of a call on the display on the called party's terminal.

Reference document [1] listed at the end of the description describes a method and a system for supplying a called party in a landline or mobile telecommunications network with information identifying a calling party. Services external to the network generate and supply this caller identity information in the form of a service page or call page without relying on calling line interface information. In the method described in the above document, the calling party's personal WAP (Wireless Application Protocol) page can be downloaded automatically to the mobile telephone of the called party following an event linked to the call (sending, receiving, refusal, etc.). The Wireless Application Protocol is a protocol for accessing Internet services on mobile terminals. The called party can browse this WAP page before, during, and after the call. In fact, a WAP home page is associated with the telephone number. This method cannot send an animation to the called party that is synchronized with the arrival of call signaling (ringer, vibrator, etc.). Moreover, if this method is used, the called party cannot receive an animation without some particular action on the part of the called party and without the called party needing to activate a browser to download a WAP page. Furthermore, the calling party cannot choose an animation contextually, i.e. the calling party cannot choose an animation as a function of the person and the present situation. The same presentation is sent regardless of the called party and the context.

An object of the invention is to enable the calling party to personalize presentation of a call made to the called party in a manner that solves these problems and to obtain the following advantages:
the possibility of surprising the called party, even though personalization by the called party or by a third party service provider is always exactly the same once it has been defined;
the possibility of announcing the subject of the call between the calling party and the called party and of setting a tone for the ensuing call; and
the possibility of indicating a degree of urgency in respect of the call.

### SUMMARY OF THE INVENTION

The invention relates to a system for linking at least two multimedia terminals connected to each other via a landline or cellular network, said system including an application server connected to a storage memory, said system being characterized in that said memory contains multimedia contents that may be chosen by a calling person and said server comprises:
means for managing entities of the network in order to synchronize the signaling of a call between a calling person's terminal and a called person's terminal with a multimedia content chosen by said calling person; and
means for adapting the multimedia content to the capabilities of the called party's terminal.

The invention also relates to a method of linking at least two multimedia terminals connected to each other via a landline or cellular network, characterized in that, before a call from a calling person's terminal to a called person's terminal, the calling person chooses a multimedia content to be sent to the called person's terminal, and said multimedia content is received by the called person's terminal synchronously with the reception of the signaling of the call.

The multimedia content may be chosen from one or more media (for example an image, photos, a video, a 2D-3D graphic animation, text, sound, etc.).

The called person can personalize the display on the receiving terminal by using a multimedia content. The multimedia content sent by the calling person and the multimedia content resulting from personalization by the called person can then share the display of the called person's terminal. Alternatively, the multimedia content sent by the calling person and the multimedia content resulting from personalization by the called person can appear in succession on the display of the called person's terminal.

Reception of signaling by the called party's terminal can be announced by a ringtone or by the terminal vibrating. The multimedia content is then displayed on the called party's terminal at the same time as the terminal rings or vibrates without any action being required of the called party.

By default, the multimedia content then remains displayed on the called party's terminal throughout the call, the called party being able to delete or save that content at any time during the call.

The multimedia content disappears from the display of the called party's terminal when the call between the calling party and the called party terminates, at which time the called party can save it in the memory of the terminal.

If the called party does not answer, the call and the multimedia content are stored in the called party's voicemail and appear when the voicemail is consulted.

If the called party does not answer and is in the network coverage area, the called party's terminal stores the multimedia content in the call log.

The calling person can either associate a multimedia content with at least one contact by means of a process known as default personalization, or can choose a multimedia content as a function of the called person and the situation by means of a process known as one-off personalization.

### BRIEF DESCRIPTION OF THE DRAWINGS

FIG. 1 shows a system of the invention;

FIG. 2 shows the various steps of a method of the invention;

FIG. 3 shows a first embodiment of the invention; and

FIG. 4 shows a second embodiment of the invention.

### DETAILED DESCRIPTION OF PARTICULAR EMBODIMENTS

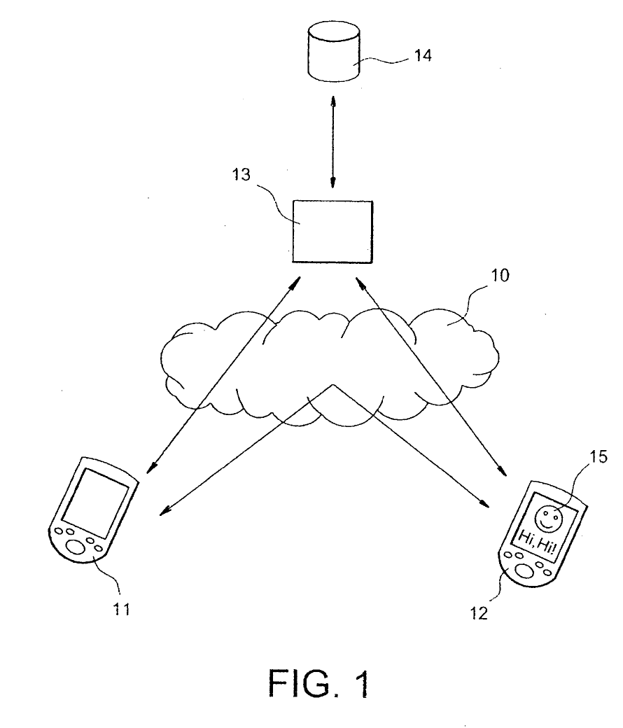

As shown in FIG. 1, the system of the invention comprises:
a landline or cellular network 10;
the terminal 11 of a calling party connected to that network;
the terminal 12 of a called party connected to that network; and
an application server 13 connected to that network and associated with a memory 14 for storing multimedia contents.

The memory 14 contains multimedia contents, for example animations or multimedia elements for creating an animation, which can be selected by the calling party, either by default to associate an animation with a contact, or on a one-off basis to associate an animation with the call that is about to be made. This memory may be physically situated either in the calling party's terminal or in the network.

If the service is an orchestra, the application server 13 is the conductor: it manages interaction between the entities of the network for routing the multimedia content 15 to the called party's terminal. This information “push” procedure entails managing a plurality of complex entities of the communications network.

The server 13:
manages the entities of the communications network in order to synchronize call signaling (ringing) and the multimedia content;
adapts the multimedia content 15 to the capabilities of the called party's terminal 12 (screen size, colors, etc.);
sets up the data link between:
   the server 13 and the called party's terminal 12 if the multimedia contents are stored by the server in the memory 14;
   the calling party's terminal 11 and the called party's terminal 12 if the contents are stored in the calling party's terminal 11; and
manages refusal of the call by the called party by sending the multimedia content 15 to a corresponding voicemail service.

The server 13 contains the application logic that implements the invention. It accesses the databases of the invention and the calling parties' personal databases. It recovers all the necessary information from the various databases and servers in order to send the required information to the terminals of the called party and the calling party.

The server 13 monitors the telephone call made by the calling party. Alerted by the combination of the calling party identifier and the called party identifier, the server 13 sends by way of a preamble to the voice call the multimedia content 15 chosen by the calling party corresponding to the identifier of the called party. The server 13 then manages the call as a function of the choices made by the called party: if the called party chooses to take the call, the server sets up a voice call. If the called party chooses not to take the call, the server 13 routes the calling party to the called party's voicemail service. When the called party listens to the voicemail, there will be a link to the calling party's multimedia content 15.

The calling party can therefore choose a multimedia content 15 that is sent to the called party on launching the call. That multimedia content 15 then appears without requiring any action of the called party and simultaneously with the arrival of the signaling for setting up the voice (and multimedia) call.

A calling party can therefore send information before the voice (and multimedia) call actually begins. It is thus possible to send the calling party's identity, the subject of the call, etc.

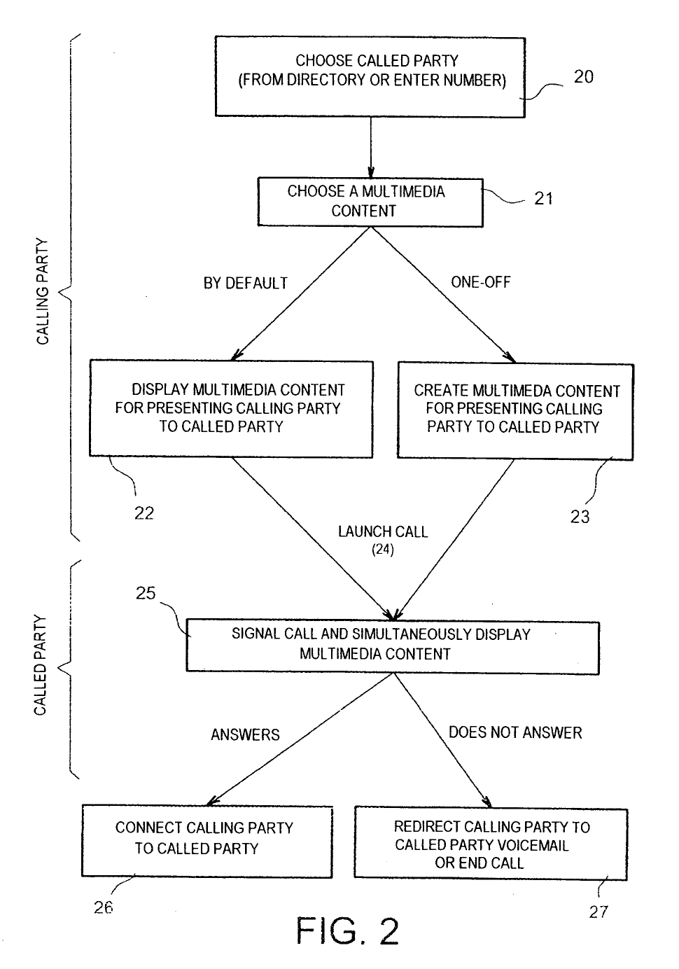

As shown in FIG. 2, the method of the invention comprises the following steps:

1) firstly, on the calling party side:
a step 20 of choosing the called party: the calling party decides to telephone a contact (the called party), either using the directory of the terminal or by entering the number directly;
a step 21 of choosing a multimedia content 15: that multimedia content 15 is then associated with the call, either by default or on a one-off basis;
either a step 22 of displaying the multimedia content 15 for presenting the calling party to the called party in the case of a default personalization procedure or a step 23 of creating the multimedia content 15 for presenting the calling party to the called party in the case of a one-off personalization procedure; and
a step 24 of launching the call: the calling party launches the call with the associated multimedia content 15;

2) and then, on the called party side:
a step 25 of signaling the call (for example by the telephone ringing or vibrating) with simultaneous display of the multimedia content 15;
either a step 26 of setting up the call between the calling party and the called party if the called party answers (the multimedia content can remain on the display of the called party's terminal 12 or the called party can store it) or a step 27 either of routing the call to called party's voicemail (the calling party is then routed to the voicemail service; if the calling party leaves a message, the multimedia content 15 is associated with that message and is sent to the called party on listening to the voicemail) or of terminating the call (if the called party or the calling party terminates the call).

If the called party does not answer and the telephone is switched on, the multimedia content 15 may be stored in the call log in the called party's terminal. Thus method of the invention enables the calling party to choose a multimedia content 15, for example an image, photos, a video, a 2D-3D (two-dimensional/three-dimensional) graphic animation, text, sound, etc. that will be sent as a preamble to a call to be made to a called party.

The multimedia content 15 considered below by way of example is a graphic animation.

The method of the invention therefore has the following features:

The animation is displayed on the called party's terminal at the same time as the ringer first sounds or the terminal vibrates, without requiring any action by the called party.

By default, the animation then remains displayed on the called party's terminal throughout the call, but the called party can delete the animation from the terminal at any time during the call.

When the call is terminated, the animation disappears. The called party can save it in the terminal's memory.

If the called party does not answer and the call is routed to voicemail, the animation may be stored in the voicemail and appear on being listened to.

If the called party does not answer and is in the coverage area of the network, the terminal can store the animation in the call log.

Thus the calling party is provided with a method of distinguishing him or herself from other persons, enabling communication to be made more easily and providing the called party with assistance in managing calls.

It is possible to associate an animation as a function of the called person and/or as a function of the situation. Personalization is therefore contextual.

It is important to note that the personalization for which the parameters are set by the called party is not eliminated. If presentation of the call to the called party by the calling party is simultaneous with presentation with parameters set by the called party, because these are complementary functions, the two presentations may appear in two separate portions of the display of the called party's terminal, for example. They may equally appear successively.
There are two complementary personalization modes:
default personalization;

one-off personalization.

Default Personalization

The calling party is able to associate selected animations with one or more parties.

Once this step has been carried out, calls initiated by the calling party are personalized by default, i.e. on each call made to a party for whom an animation has been selected, that animation is sent. Personalization is effected as a function of the called party.

It is then a very simple matter to modify the choice of animations or to deactivate personalization temporarily.

One-Off Personalization

One-off personalization enables the presentation of the call to be personalized not only as a function of the called party but also as a function of the situation at the time of making the call.

In this case the animation that is sent is valid for only one call. In other words, at the time of making the call, the calling party can choose to associate with it an animation for the precise situation that applies at that time.

If there is any predefined personalization, then one-off personalization takes priority over default personalization.

The remainder of the description describes two embodiments of the method of the invention:
a first embodiment based on the CAMEL/OSA (Customized Applications for Mobile Network Enhanced Logic/Open Service Access) technology: this kind of technology is described in reference documents [2] and [3];
a second embodiment based on the standard Session Initialization Protocol (SIP): this kind of protocol is described in reference document [4].

### First Embodiment

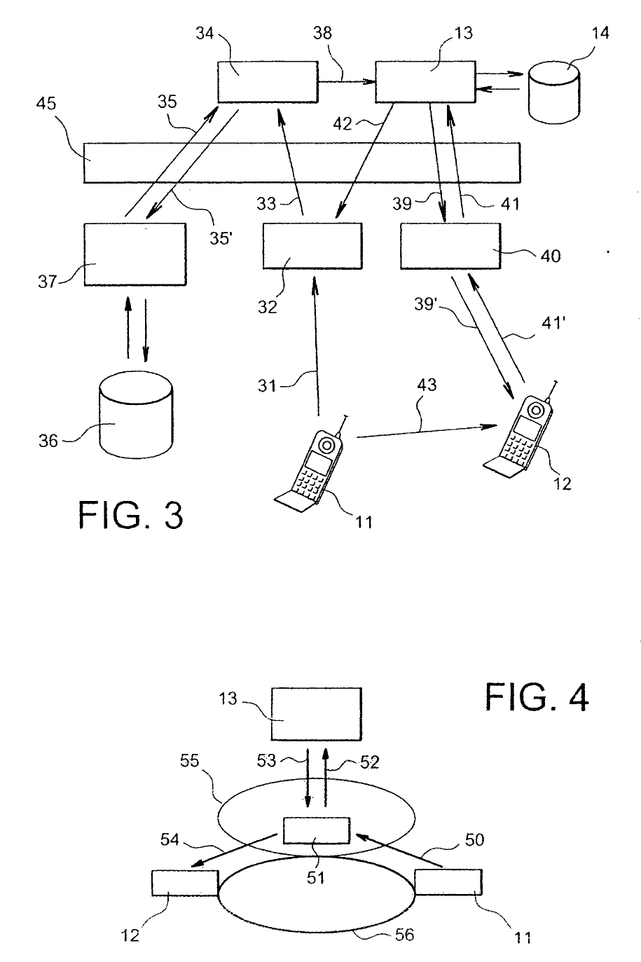

In the first embodiment based on the CAMEL/OSA technology and shown in FIG. 3, the method of the invention is triggered by a CAMELO-CSI mark (marker in the information stream) (outgoing call to the MSC (mobile service switching centre)).

The Service Capabilities Servers (SCS) used are a call control server and a user interaction server. The call control server controls the call by the calling party. The user interaction server initiates the mechanism for “pushing” information from the server to the called party without requiring a request from the called party..

The supplementary Service Capabilities Features (SCF) enable the application to access the calling party's user profile, of which the multimedia content forms part. Accordingly, at the time of an outgoing call, an entity (service broker) that manages the services of the calling party is triggered and, after consulting the user profile, decides to hand call control over to the application of the invention.

In a preliminary step, when writing all the starting data of the application of the invention (known as “provisioning”), the application requests the call control server 32 to notify it of outgoing calls from calling parties who have subscribed to the service for personalization by the calling party of the presentation of calls to the called party (OSA permitted call notification method). This server activates the CAMELO/CSI mark.

The following succession of steps is then executed:

1. The call is triggered by the calling party on the terminal 11 (arrow 31). As the calling party has a CAMELO-CSI mark, a message is sent to the call control server 32 to warn it of call triggering.

2. The call control server 32 invokes (arrow 33) the OSA call event notify method on the service broker entity 34 to notify the outgoing call to it.

3. The service broker entity 34 consults the user profile 36 via the user profile management server 37 (arrows 35 and 35′) to find out if it can hand control of the call over to the application server 13 of the invention.

4. The service broker entity 34 hands call control over to the application server 13 of the invention (arrow 38), which looks in the memory 14 for the multimedia content to be sent.

5. The application server 13 of the invention sends the user interaction server 40 a request to send the multimedia content to the called party's terminal 12 (“SendInfoAndCollectReq”—arrows 39 and 39′). It uses the OSA method to send the request and to recover the information.

6. The called party responds (arrows 41 and 41′) that it will be taking the call using the OSA method to send the request for recovery of the information (“SendInfoAndCollectReq”).

7. The application server 13 of the invention invokes the OSA method of call release (“DeassignCall”) to notify the call control server 32 that it is no longer interested in the call (arrow 42): it hands call control over to the network, which then has to continue the call set-up process. If the called party refuses the call, the application server 13 of the invention invokes the OSA release method to request the network to release the call.

8. The call is set up between the calling party 11 and the called party 12 (arrow 43).

In FIG. 3 the area 45 denotes the Common Object Request Broker Architecture (CORBA).

### Second Embodiment

The second embodiment shown in FIG. 4 is based on the Session Initiation Protocol (SIP) used in the IP Multimedia Subsystem (IMS).

With the IMS system, from the moment at which a user registers, that user has a data protocol context (PDP context) that is always active and that is used for SIP signaling. This context is used for SIP signaling in the second embodiment.

The application logic of the invention is implemented in a SIP application server 13 using an intelligent network architecture.

The application server 13 is connected to the Serving-Call State Control Function (S-CSCF) entity 51 of the UMTS 3^{rd} generation mobile network (version 5). The entity 51 is responsible for Internet Protocol (IP) call control for users who have subscribed to the service for personalizing call presentation.

If the user is registered for the call presentation service, the user database HSS (equivalent to the Home Location Register (HLR) in UMTS version 5) contains a link to the entity 51.

During call set-up, data concerning the user is recovered from the database HSS. The call is then redirected to the entity 51, which in turn redirects it to the application server 13 running the application of the invention.

Once the calling party has subscribed to the service for personalizing call presentation, the calling party can:
launch a standard voice call, in the case of the default service;
or choose an animation and launch a normal voice call, in the case of the one-off service.

The uniform resource locator (URL) identifying the multimedia content is sent to the called party in the SIP INVITE signaling message (request sent to the called party in a signaling message).

For example, the called party sees the calling party's animation displayed on the terminal 12 and decides whether to take the call or not.

The voice call is connected through if the called party chooses to take the call.

There following steps are therefore executed:

1. The calling party launches the call using the terminal 11 (arrow 50).

2. The S-CSCF entity 51 redirects the call to the application server 13 that contains the application of the invention (arrow 52).

3. The application server 13 of the invention executes the application of the invention and sends the “Push” content to the terminal (arrow 53).

4. The “Push” content in the SIP INVITE request is routed to the called party 12 (arrow 54). The terminal of the called party 12 can then download the multimedia content from the calling party.

The reference 55 denotes the IP multimedia subsystem. The reference 56 denotes the packet domain (PS domain).

The subsequent steps may be summarized in the following manner. A multimedia session is initiated. The called party sees the calling party's animation displayed on the terminal 12 and decides whether to take the call, for example. The voice call is connected through if the called party chooses to take the call.

The called party and the calling party are then connected to the IMS system and have an active packet data protocol (PDF) context. If the above conditions are not met, the called party does not receive the calling party's animation.

### REFERENCES

[1] WO 01/54373
[2] Internet Site www.3qpp.org (Camel or “Customized Applications for Mobile Network Enhanced Logic”: 23078, 23178, 23278)
[3] Internet Site www.3qpp.org (OSA or “Open Service Access”: 23127, 23927, 23198 series, 23998 series)
[4] Internet Site www.3qpp.org (SIP or “Session Initiation Protocol”: 29962, 24228, 24229)

1. A system for linking at least two multimedia terminals connected to each other via a landline or cellular network, comprising:
an application server; a memory that contains multimedia contents that may be chosen by a calling person,
wherein said server comprises means for managing entities of the network in order to synchronize the signaling of a call from a terminal of a calling person to a terminal of a called person with a multimedia content chosen by said calling person.

2. A method of linking at least two multimedia terminals connected to each other via a landline or cellular network, wherein, before a call from the terminal of a calling person to the terminal of a called person, the calling person chooses a multimedia content to be sent to the terminal of the called person, and said multimedia content is received by the terminal of the called person synchronously with the reception of the signaling of the call.

3. The method according to claim 2, wherein said multimedia content received by the terminal of the called person is displayed conjointly with or after another multimedia content personalized beforehand by the called person.

4. The method according to claim 2, wherein said multimedia content received by the terminal of the called person by default remains displayed on said terminal throughout the call, the called person being able at any time during the call to delete the display of said content.

5. The method according to claim 4, wherein the display of said multimedia content on the terminal of the called person disappears when the call is terminated.

6. The method according to claim 2, wherein, if the called person does not answer, the call and the multimedia content are stored in the voicemail of the terminal of the called person and appear when the voicemail is consulted.

7. The A method according to claim 2, wherein, if the called person does not respond and is in the network coverage area, the multimedia content is stored in the call log of the called person's terminal.

8. The method according to claim 2, wherein, before a call, the calling person associates a multimedia content with at least one person to be called.

9. The method according to claim 2, wherein, at the time the calling person sets up a call to a called person, the calling person associates a multimedia content with said called person and with the situation relating to the call.

10. An application server belonging to a landline or cellular network and comprising:
means for managing entities of the network in order to synchronize the signaling of a call from a terminal of a calling person to a terminal of a called person with a multimedia content chosen by said calling person.

11. A communications terminal including means for selecting a person to be called, said terminal including:
means for associating a multimedia content with one or more persons to be called by said terminal; and
means for setting up a call to a terminal belonging to said person to be called conjointly with sending said multimedia content.

12. The system of claim 1, wherein said server further comprises means for adapting the multimedia content to the capabilities of the terminal of the called person.

13. The application server of claim 10, further comprising means for adapting the multimedia content to the capabilities of the called person's terminal.
